(19) United States
(12) Patent Application Publication
(10) Pub. No.: US 2024/0031360 A1
(43) Pub. Date: Jan. 25, 2024

(54) METHOD AND SYSTEM FOR LOG-IN AND AUTHORIZATION

(71) Applicant: DBS BANK (TAIWAN) LTD., Taipei City (TW)

(72) Inventors: Chia-Hua WU, Taipei City (TW); Chun-Chin PENG, Taipei City (TW); Shih-Chieh CHUEH, Taipei City (TW); Kuan-Wen LIN, Taipei City (TW)

(73) Assignee: DBS BANK (TAIWAN) LTD., Taipei City (TW)

(21) Appl. No.: 18/123,126

(22) Filed: Mar. 17, 2023

Related U.S. Application Data
(60) Provisional application No. 63/369,121, filed on Jul. 22, 2022.

(51) Int. Cl. H04L 9/40

(52) U.S. Cl. CPC H04L 63/0838; H04L 63/0861

(57) ABSTRACT

According to embodiments of the present invention, method and system for log-in and authorization are disclosed. The system comprises a user device, a server and a mobile device. The user device issues a log-in request. The server receives the log-in request through communication with the user device via a first communication link, and outputs a digital token as one time passwords (OTPs) to the user device in response to the log-in request, for display thereon. The mobile device comprises a communication unit, a camera and a processor. The communication unit communicates with the server via a second communication link. The processor is configured to capture the digital token through the camera, transmit the captured digital token to the server for verification, authenticate a biometric characteristic, and output a notice indicating successful biometric authentication to the server to confirm authorization of the user device. Then, the user device can be used to proceed with an operation with a user account.

### FIELD OF THE INVENTION

The present invention generally relates to a method and system for log-in and authorization, and specifically, the method and system for log-in and authorization utilizing a digital token and biometric characteristic.

### BACKGROUND OF THE INVENTION

Security vulnerability is a key issue when offering trendy e-banking service. One factor authentication (1FA) merely utilizing an account and passwords to log-in is vulnerable because the account and passwords may oftentimes be stolen or inadvertently leaked due to malware attack or phishing attack. Thus, 1FA is not a sound solution to control risks of high risk transactions, and two factor authentication (2FA) must be deployed to promote security measure of data of the account.

### SUMMARY OF THE INVENTION

One aspect of the present invention is to provide a method and system for log-in and authorization. With a mobile device, a digital token, as one time passwords (OTPs), is captured, and a biometric characteristic is authenticated, so as to assist in confirming authorization and logging-in of the user device. Preferably, the digital token, biometric characteristic, along with information such as an account and passwords, may be utilized for two factor authentication (2FA). As such, a server may authorize the user device to proceed with an operation, such as a high risk transaction. Therefore, with the method and system for log-in and authorization of the present invention, users do not need to remember complicate passwords. In such a case, countermeasure against risks of malware attack and phishing attack may be effective to promote security of data of the account.

In one aspect of the invention, an embodiment of the invention is provided that a system for log-in and authorization comprising a user device, a server and a mobile device. The user device may issue a log-in request. The server may communicate with the a user device through a first communication link and thereby receive the log-in request and in response to the log-in request, output a digital token, as one time passwords (OTPs), to the user device for display thereon. The mobile device may comprise a communication unit, a camera and a processing unit. The communication unit may communicate with the server through a second communication link. The processing unit may be configured to capture the digital token through the camera, transmit the captured digital token to the server for verification, authenticate a biometric characteristic, and output a notice indicating successful biometric authentication to the server to confirm authorization of the user device so as to proceed with an operation.

In another aspect of the invention, an embodiment of the invention is provided that a method for log-in and authorization, applied in a system for log-in and authorization, comprising steps of with a user device, issuing a log-in request to a server through a first communication link; with the server, outputting a digital token, as one time passwords, to the user device for display thereon in response to the log-in request; with a processing unit of a mobile device, capturing the digital token through a camera of the mobile device, and transmitting the captured digital token to the server for verification through communicating of a communication unit of the mobile device with the server through a second communication link; and with the processing unit of the mobile device, authenticating a biometric characteristic and outputting a notice indicating successful biometric authentication to the server through the communication with the server via the second communication link to confirm authorization of the user device so as to proceed with an operation.

### BRIEF DESCRIPTION OF THE DRAWINGS

Various objects and advantages of the present invention will be more readily understood from the following detailed description when read in conjunction with the appended drawing, in which:

FIG. 1 shows a system architecture of a system for log-in and authorization according to an embodiment of the invention;

FIG. 2 illustrates a flow chart of a method for log-in and authorization according to an embodiment of the invention;

FIG. 3 illustrates another flow chart of a method for log-in and authorization according to an embodiment of the invention.

### DESCRIPTION OF EMBODIMENTS OF THE INVENTION

For a more complete understanding of the present disclosure and its advantages, reference is now made to the following description taken in conjunction with the accompanying drawings, in which like reference numbers indicate like features. Persons of ordinary skill in the art having the benefit of the present disclosure will understand other variations for implementing embodiments within the scope of the present disclosure, including those specific examples described herein. The drawings are not limited to specific scale and similar reference numbers are used for representing similar elements. As used in the disclosures and the appended claims, the terms “example embodiment,” “exemplary embodiment,” and “present embodiment” do not necessarily refer to a single embodiment, although it may, and various example embodiments may be readily combined and interchanged, without departing from the scope or spirit of the present disclosure. Furthermore, the terminology as used herein is for the purpose of describing example embodiments only and is not intended to be a limitation of the disclosure. In this respect, as used herein, the term “in” may include “in” and “on”, and the terms “a”, “an” and “the” may include singular and plural references. Furthermore, as used herein, the term “by” may also mean “from”, depending on the context. Furthermore, as used herein, the term “if” may also mean “when” or “upon”, depending on the context. Furthermore, as used herein, the words “and/or” may refer to and encompass any and all possible combinations of one or more of the associated listed items.

The present invention discloses various examples for a method and a system for log-in and authorization. With a mobile device, a digital token, as one time passwords (OTPs), is captured, and a biometric characteristic is authenticated, so as to assist in confirming authorization and logging-in of the user device. Preferably, the digital token, biometric characteristic, along with information such as an account and passwords, may be utilized for two factor authentication (2FA). As such, a server may authorize the user device to proceed with an operation, such as a high risk transaction. Therefore, with the method and system for log-in and authorization of the present invention, users do not need to remember complicate passwords. In such a case, countermeasure against risks of malware attack and phishing attack may be effective to promote security of data of the account.

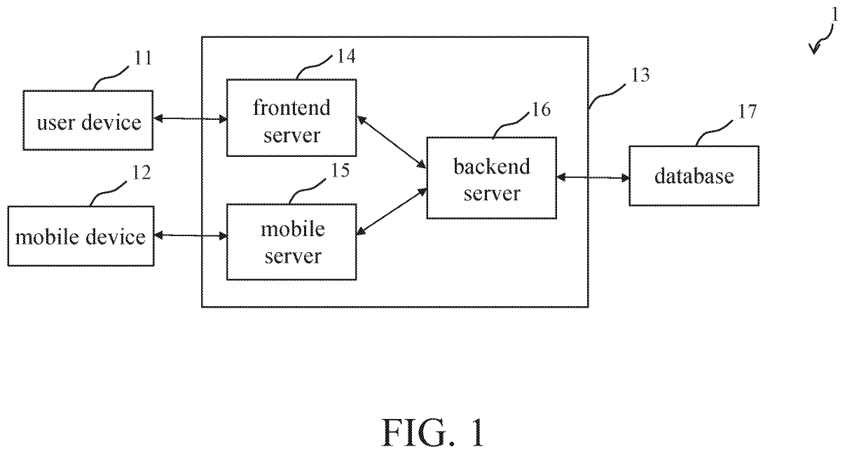

Referring to FIG. 1, an embodiment of a system for log-in and authorization 1 according to the present invention is shown. The system for log-in and authorization 1 may comprise at least one user device 11, at least one mobile device 12, at least one server 13 and an optional database 17. The user device 11 may be, but not limited to, a computer, a mainframe computer, a tablet computer or other types of electronic device. In the user device 11, a browser may store a set of account and passwords. With a communication link unit (not shown), the user device 11 may generate a first communication link for mutual communication with a frontend server 14. For example, packages may be transmitted between the browser of the user device 11 and the server 13 in complying with TPC/IP (Transmission Control Protocol/Internet Protocol), so as to transmit requests of the user device 11 to the server 13 and data of the server 13 to the user device 11.

The mobile device 12 may be, but not limited to, a mobile phone, a personal digital assistant (PDA), a tablet computer or other types of mobile electronic device. The mobile device 12 may comprise a communication unit (not shown), a camera (not shown) and a processor (not shown). The processor may connect with the communication unit and the camera and control the operation of the communication unit and the camera. With the communication unit, the mobile device 12 may generate a second communication link for mutual communication with the server 13. The communication unit here may be, but not limited to, a wireless communication link unit, a wire communication link unit, etc. For example, the communication unit here may be a network chip building up Bluetooth communication, 3G communication, 4G communication or 5G communication. The processor may be, but not limited to, a central processing unit (CPU), graphics processing unit (GPU), etc. Preferably, the processor may calculate. The camera may be, but not limited to, a lens-style camera, a digital camera, etc. Preferably, the camera may take pictures or images.

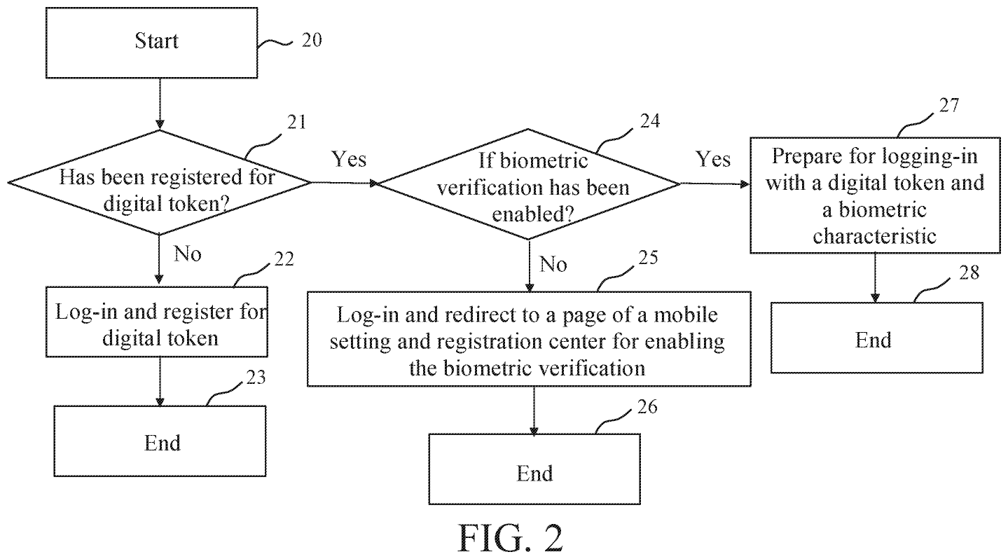

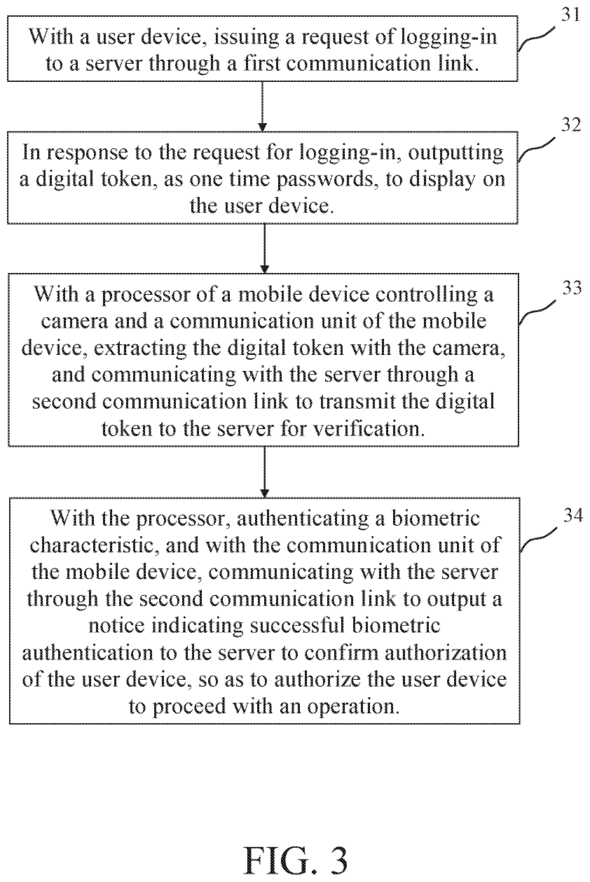

The server 13 here may comprise the frontend server 14, a mobile server 15 and a backend server 16. A client-server model may be form between the server 13 and/or the mobile device 12. The frontend server 14 may correspond to the user device 11. The mobile server 15 may correspond to the mobile device 12. The backend server 16 may mutually communicate with the frontend server 14 and the mobile server 15. Users may be authorized by the server 13 which successfully authorizes the user device 11 with the user device 11 and/or the mobile device 12 performing the flow chart of the for log-in and authorization shown in FIGS. 2 and 3 of the present embodiment. Then, the server 13 may perform at least one operation in complying with the request of the user device 11, such as providing corresponding data or operating correspondingly.

Referring to FIG. 2, which shows a flow chart of a method for log-in and authorization, the users may utilize the user device 11 and/or mobile device 12 to register authentication of a digital token and a biometric characteristic. After starting the flow in a step 20, if a user has registered for the digital token is determined in a step 21. If the user has not registered for the digital token, in a step 22, the user may register for the digital token with the user device 11 and/or mobile device 12 by logging-in the server 12 with the account and the passwords and linking the user device 11 to a specific mobile application (APP). Here, a series of flow for logging-in and authorization may be performed to register, but not limited to, such as linking the mobile phone, sending verification code via short message service (SMS) or email, etc. Afterwards, in a step 23, the flow may be ended. If it is determined that the user has registered for digital token in the step 21, it will go to a step 24 to determine if the user has set to enable biometric verification. If biometric verification has not been enabled, in a step 25, the user device 11 and/or mobile device 12 may be utilized for logging-in and redirected to a page of a mobile setting and registration center for enabling the biometric verification. At this time, the user may set a biometric characteristic, such as a fingerprint, face image, etc. and register for enabling the biometric verification. Then, in a step 26, the flow is ended. If the determination performed in the step 24 is that the biometric verification has been enabled, the flow will go to a step 27 to finish preparation of logging-in with the digital token and biometric characteristic that contribute to 2FA. Then, in a step 28, the flow may be ended. Please note that an additional step of determining if enabling biometric verification before the step 23. More step(s) may be added between any two steps or before/after any step, which may be elaborated into or sub-step(s), mentioned above.

Referring to FIGS. 1 and 3. FIG. 3 shows a 2FA flow chart of a method for log-in and authorization utilizing a digital token and a biometric characteristic according to an embodiment of the invention, which may be performed with the system for log-in and authorization 1, as shown in FIG. 1. At first, in a step 31, a user may issue a request of logging-in to the server 13 with the user device 11 through the first communication link, and preferably, the user may surf a specific webpage through the first communication link.

After the server 13 receives the request for logging-in, in a step 32, in response to the request for logging-in, the server 13 may output a digital token, as one time passwords, to display on the user device 11. For example, the digital token may be show on the specific webpage displaying on the user device 11. Because the digital token, as one time passwords, is only valid during a certain time period, security may be promoted. For example, the digital token will be invalid after turning off the browser. Preferably, in the step 32, the digital token may be a quick response code (QR code) generated with the server's 13 calculation.

Then, in a step 33, the user may operate the mobile device 12 for extracting the digital token. Specifically, at this time, the user may start the specific APP up to operate in the mobile device 12 and then scan the digital token shown on the user device 11 with the specific APP. Preferably, after extracting the digital token, the server 13 may determine if the user has registered for digital token, and refuse to log-in if the user has not registered. Further, when starting the APP up, the APP may automatically pop up a warning message to remind the user to check uniform resource locator (URL) of the specific webpage of the digital token shown by the user device 11. The digital token may not be extracted until the user confirms, such as pressing a button of “Confirmed and Proceed.” After the processing unit of the mobile device 12 extracts an image of the digital token in complying with the APP which is controlled by the operation of the user, the image may be transmitted to the server 13 for verification through the second communication link between the communication unit and the server 13. The image may be verified by the mobile server 15 at first and then the backend server 16 after the mobile server 15 verifies the digital token the image represented successfully and transmit the digital token to the backend server 16 for verification. The backend server 16 may confirm if the received digital token is identical to the digital token generated in the step 32. If so, the digital token is verified successfully. After the backend server 16 verifies the digital token successfully, a request indicating that the user device 11 hides the display of the digital token may be transmitted to the user device 11. A hardware security module (HSM) of the backend server 16 may encrypt, store and manage the digital tokens. Meanwhile, the backend server 16 may issue a confirmation notice indicating successful verification of the digital token to the user device 11 and the mobile device 12. After the user device 11 receives the confirmation notice from the backend server 16, the user device 11 may log in the server 13 with the set of account and passwords stored in the browser. After the mobile device 12 receives the confirmation notice from the backend server 16, preferably, a warning message may be shown to remind the user that the user device 11 is logging-in the server 13. Then, the user may confirm with a sliding motion.

Afterwards, in a step 34, the mobile device 12 may automatically perform biometric verification to identify the user. Here, with the processor, the biometric characteristic, such as a fingerprint or a face image, may be authenticated, and then with the communication unit of the mobile device 12, communication with the server 13 is carried out through the second communication link. When matching the biometric characteristic, a notice indicating successful biometric authentication is output to the server 13 for confirmation of successful verification of the user device 11. Then, the server 13 may authorize the user device 11 for at least one operation. Specifically, after the mobile server 15 receives the notice indicating successful biometric authentication, the digital token may be authenticated, and the backend server 16 may authenticate an identity of the user corresponding to the set of account and passwords utilized for logging-in. Both the user device 11 and the mobile device 12 may additionally transmit its geolocation information to the server 13 for fraud risk scoring. For example, if a distance between the geolocation of the user device 11 and that of the mobile device 12 exceeds a certain amount, it may be determined that the user device 11 and the mobile device 12 are not operated by the same person which leads to higher risk. Preferably, after the server 13 authorizes the user device to proceed with at least one operation, the APP in the mobile device 12 may selectively and automatically show a warning message remind the user the authorization the user has, for example, the user has logged-in the server 13.

Then, after the user has been authenticated, with the user device 11, a request from the backend server 16 may be received. The request may redirect the browser of the user device 11 to a webpage of operation in which an operation, such as high risk transaction, large transfer, large remittance, may be performed.

As mentioned above, the method and system for log-in and authorization according to the present invention may extract the digital token shown on the user device, as one time passwords, with the mobile device for verification in the server, and confirm the successful verification of the user device with the digital token and biometric characteristic. Preferably, account and passwords may be further utilized to achieve 2FA. The authorization may permit the user device to perform at least one operation, such as a high risk transaction. In such as case, real-time and diverse solutions of logging-in and authorization may be provided. Further, with the method and system for log-in and authorization according to the present invention, the users may not need to remember complicate passwords. In such a case, countermeasure against risks of malware attack and phishing attack may be effective to promote security of data of the account.

It is to be understood that these embodiments are not meant as limitations of the invention but merely exemplary descriptions of the invention with regard to certain specific embodiments. Indeed, different adaptations may be apparent to those skilled in the art without departing from the scope of the annexed claims.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A system for log-in and authorization, comprising:
a user device, issuing a log-in request;
a server, communicating with the a user device through a first communication link and thereby receiving the log-in request and in response to the log-in request, outputting a digital token, as one time passwords, to the user device for display thereon; and
a mobile device, comprising a communication unit, a camera and a processing unit, the communication unit communicating with the server through a second communication link, the processing unit being configured to capture the digital token through the camera, transmit the captured digital token to the server for verification, authenticate a biometric characteristic, and output a notice indicating successful biometric authentication to the server to confirm authorization of the user device so as to proceed with an operation.

2. The system for log-in and authorization according to claim 1, wherein the digital token is a QR code.

3. The system for log-in and authorization according to claim 1, wherein the server comprises a mobile server and a backend server, and both the mobile server and the backend server communicate with the mobile device.

4. The system for log-in and authorization according to claim 3, wherein the backend server further comprises a hardware security module encrypting, storing and managing the digital token.

5. The system for log-in and authorization according to claim 3, wherein after the backend server verifies the digital token successfully, the backend server transmits a request indicating hiding the digital token to the user device.

6. The system for log-in and authorization according to claim 3, wherein the user device further comprises a browser storing a set of account and passwords, and after the user device receives a confirmation notice from the backend server, the user device logs-in the server with the set of account and passwords.

7. A method for log-in and authorization, applied in a system for log-in and authorization, comprising steps of:
with a user device, issuing a log-in request to a server through a first communication link;
with the server, outputting a digital token, as one time passwords, to the user device for display thereon in response to the log-in request;
with a processing unit of a mobile device, capturing the digital token through a camera of the mobile device, and transmitting the captured digital token to the server for verification through communicating of a communication unit of the mobile device with the server through a second communication link; and
with the processing unit of the mobile device, authenticating a biometric characteristic and outputting a notice indicating successful biometric authentication to the server through the communication with the server via the second communication link to confirm authorization of the user device so as to proceed with an operation.

8. The method for log-in and authorization according to claim 7, further comprising:
with the server, generating a QR code as the digital token.

9. The method for log-in and authorization according to claim 7, further comprising:
after a backend server of the server verifies the digital token successfully, the backend server transmitting a request indicating hiding the digital token to the user device.

10. The method for log-in and authorization according to claim 7, further comprising:
with a browser of the user device, storing a set of account and passwords, and after the user device receives a confirmation notice from the backend server, the user device logging-in the server with the set of account and passwords.

11. The method for log-in and authorization according to claim 7, further comprising:
with a mobile server of the server, authenticating the digital token; and
with a backend server of the server, authenticating a user corresponding to the set of account and passwords.

12. The method for log-in and authorization according to claim 11, further comprising:
after authenticating the user, with the user device, receiving a request from the backend server to redirect the browser of the user device to an operation webpage.

13. The method for log-in and authorization according to claim 11, further comprising:
with the user device, register the user to startup authentication with the digital token and the biometric characteristic.
